(19) United States
(12) Patent Application Publication
(10) Pub. No.: US 2017/0233079 A1
(43) Pub. Date: Aug. 17, 2017

(54) OPTIMIZED SHEAR PLUNGER FOR AIRCRAFT SEATS

(71) Applicant: UCAK KOLTUK URETIMI SANAYI VE TICARET ANONIM SIRKETI, Istanbul (TR)

(72) Inventor: Zoltan KOVAGO, Istanbul (TR)

(21) Appl. No.: 15/115,310

(22) PCT Filed: Oct. 13, 2014
(86) PCT No.: PCT/TR2014/000377

§ 371 Date: Jul. 29, 2016

(51) Int. Cl. B64D 11/06

(52) U.S. Cl. CPC B64D 11/0696

(57) ABSTRACT

A shear plunger which is a part of a fitting group which connects an aircraft seat to a seat track which is placed on the inside floor of the aircraft. The shear plunger has a flat transition area which is flat and which is formed between a second radiused surface and a second radiused transition surface, a first radiused transition surface which has a radiused form and which is formed between the first radiused surface and second radiused surface, the second radiused transition surface having a radiused form and which is formed between the flat transition area and the third radiused surface in order to provide maximum surface contact between the shear plunger and the seat track.

### TECHNICAL FIELD

The present invention is related to shear plunger which is an aircraft seat part used in seat structure and its function is to keep the seat in its position which is mandatory under static and dynamic load conditions. Seats are certified by means of not allowing seat to move throughout seat track once assembled and fixed.

### STATE OF ART

During prior art search, a US patent application numbered U.S. Pat. No. 5,762,296 and titled as Pivot for rear seat track fitting is encountered. The application is related with a track fitting assembly for removably securing a seat through a swivel bearing to a generally channel-shaped track secured to the fuselage of an aircraft. Another patent application is a US patent application numbered US2011013972 and titled as seat track fitting. The fitting described in the application, in one embodiment, include the main body, at least one shear plunger assembly, and the track comprising the pair of lips, where the pair of lips comprise at least one circular opening. The at least one shear plunger assembly comprises a shear pin and a button. The at least one shear pin assembly comprises a disengaged position, wherein the button extends from the main body and the shear pin is positioned within the main body.

In the current state of art, seat manufacturers either use 2 different shear plungers having different diameters or use 1 shear plunger which fits in all cases. But both of these methods have disadvantages. Using 2 different shear plunger means 2 different tools to manufacture 2 different components and one of them would have really low quantity. This is not efficient.

Also, when there are 2 different components, manufacturer should take some precautions to make sure one is not mistakenly assembled for the other. Tracking of which seat should have the special dimensioned part would be additional workload and in some cases may slow the assembly line.

Method 2 nullifies these effects by having one type of plunger for all conditions. Yet this means shear plunger diameter should be between 0.703-0.713 inches which will weaken the structure considerably. We should take note of recommended plunger diameter is 0.78 inches by most airframe manufacturers.

As a result of the abovementioned drawbacks and the insufficiencies of the present solutions regarding the subject, an improvement is required to be made in the related technical field.

### OBJECTS OF THE PRESENT INVENTION

Developed with the inspiration of the present conditions, the present invention aims to eliminate the abovementioned drawbacks.

The object of the present invention is to provide larger diameter value which means more material and more surface contact, thanks to the form of the shear plunger which subjected to invention. This is important because this part should endure high loads and should keep the seat on its track. This is a huge gain considering there will be one type of plunger which fits the track splice condition but also provides larger diameter for better endurance.

In order to achieve the abovementioned objects, a shear plunger which is a part of a fitting group which connects aircraft seat to a seat track which is placed on the inside floor of the aircraft and which comprises:
a radiused surface 1 which has 0.78 inch diameter,
a radiused surface 2 which has 0.78 inch diameter,
a radiused surface 3 which has 0.78 inch diameter.
a flat transition area which is flat; and which is formed between radiused surface 2 and radiused transition surface 2;
a radiused transition surface 1 which has radiused form; and which is formed between radiused surface 1 and radiused surface 2,
a radiused transition surface 2 which has radiused form; and which is formed between flat transition area and radiused surface 3 in order to provide maximum surface contact between shear plunger and seat track.

The structural and characteristic features and all the advantages of the present invention will be more clearly understood thanks to the figures below and the detailed description written with reference to those figures; therefore, the evaluation is required to be made by taking said figures and the detailed description into consideration.

### FIGURES FOR UNDERSTANDING THE PRESENT INVENTION

FIG. 1 shows the perspective view of the aircraft seat which is connected to seat track.

FIG. 2 shows the perspective view of the fitting group connected to rear leg.

FIG. 3 shows the two dimensional view of the fitting group from top.

FIG. 4a shows the perspective view of seat track, shear plunger and rear main fitting body which are connected to each other.

FIG. 4b shows two dimensional view of seat track, shear plunger and rear main fitting body which are connected to each other, from top.

FIG. 5 shows two dimensional view of seat tracks which are adjacent to each other, from top.

FIG. 6a shows the perspective view of the shear plunger, from bottom.

FIG. 6b shows another perspective view of the shear plunger, from bottom.

FIG. 6c shows another perspective view of the shear plunger, from bottom.

FIG. 6d shows two dimensional view of the shear plunger, from top.

FIG. 7 shows a shear plunger belongs to prior art.

FIG. 8a shows contact of the surfaces of shear plunger and seat track.

FIG. 8b shows detailed view of “C” which is seen in FIG. 8a.

FIG. 9 shows contact of the surfaces of shear plunger belongs to prior art and seat track.

### DESCRIPTION OF PART NUMERALS

1. Fitting group
2. Seat track
3. Seat track connection line
4. Shear plunger
41. Radiused surface 1
42. Radiused surface 2
43. Radiused surface 3
44. Flat transition area
45. Radiused transition surface 1
46. Radiused transition surface 2
5. Rear main fitting body
6. Rear leg
7. Seat
8. Contact surface

The drawings do not need to be scaled necessarily and the details that are not necessary for understanding the present invention may have been ignored. In addition, the elements that are at least identical to a great extent or at least have identical functions to a great extent are referred with the same numeral.

### DETAILED DESCRIPTION OF THE PRESENT INVENTION

In this detailed description, the preferred embodiments of the shear plunger (4) described only for the subject to be understood better.

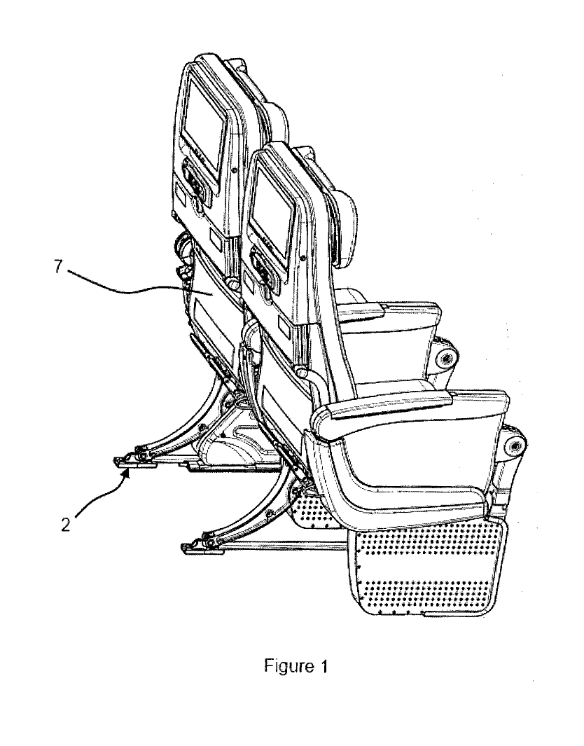

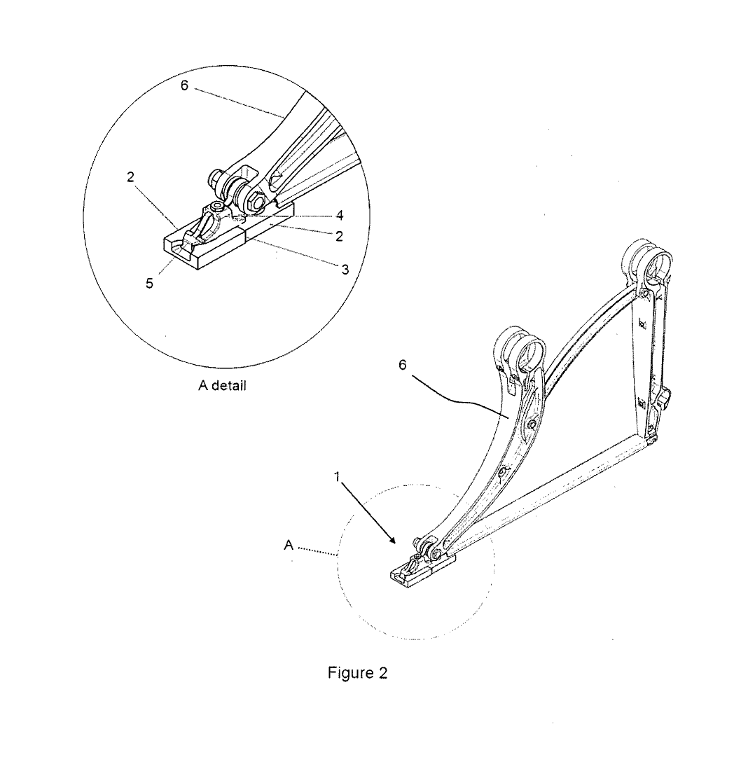

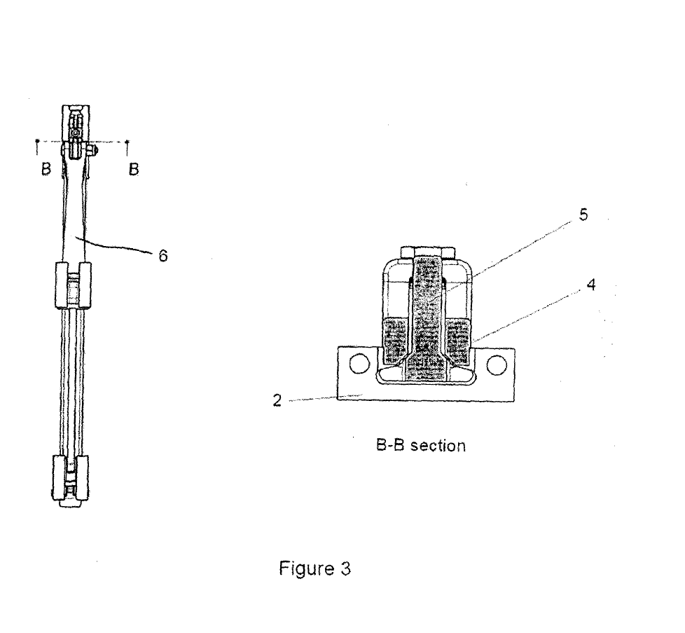

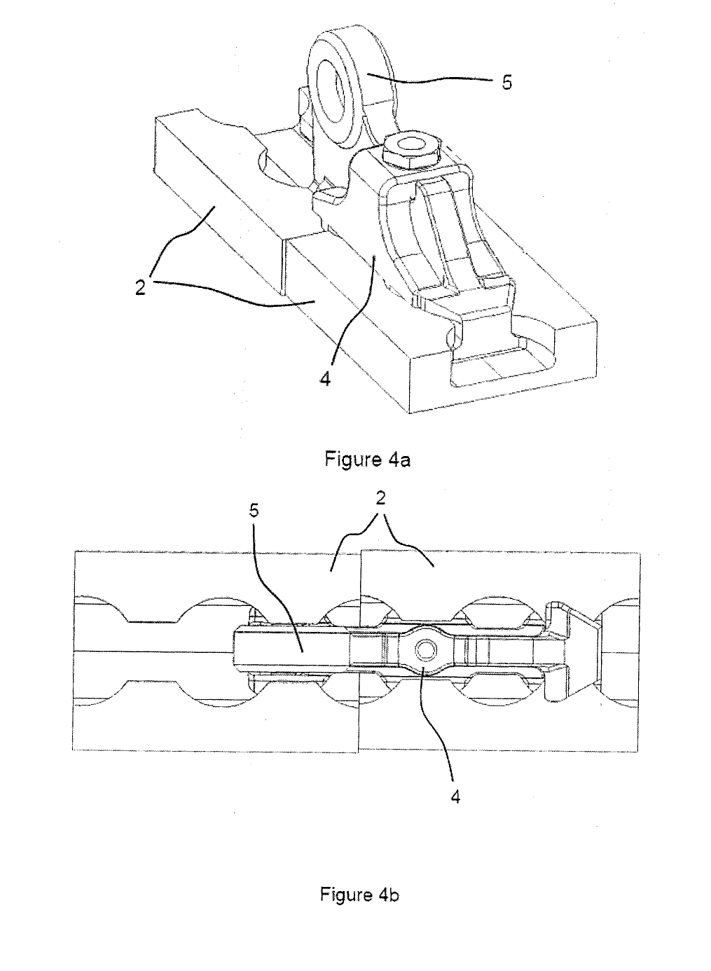

Fitting group (1) comprises; seat track (2), shear plunger (4) and rear main fitting body (5) (FIG. 2). Said fitting group (1) provides connection of seat (7) to the aircraft by being connected to the seat tracks (2) (FIG. 1).

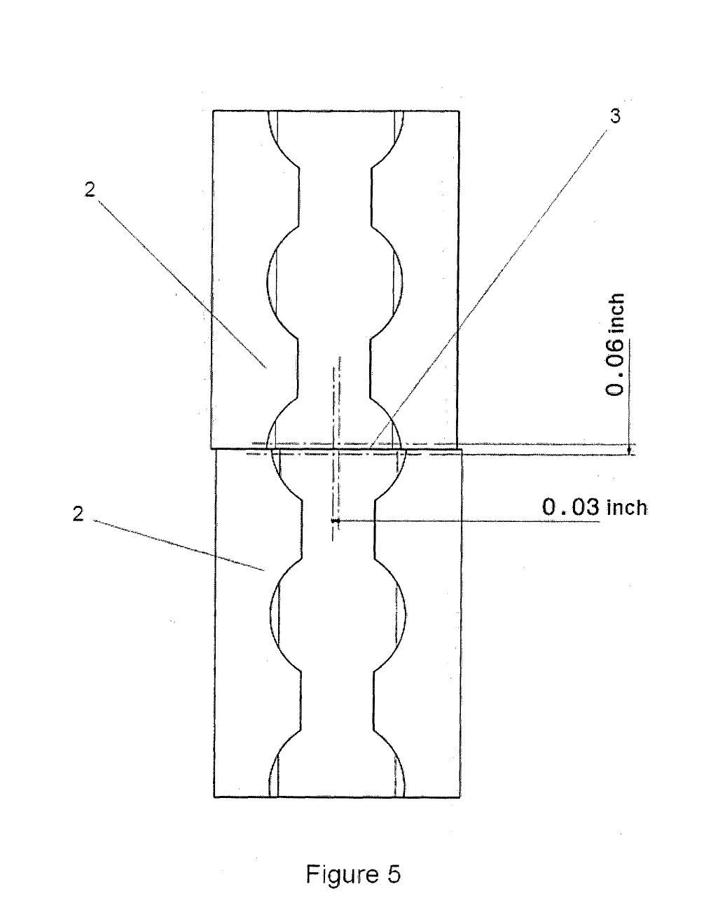

Seat tracks (2) are placed on the inside floor of the aircraft. Only one seat track (2) can not be positioned along all the aircraft. Thus, seat tracks (2) which are produced by having certain lengths and then connected to each other at the seat track connection lines (3). In the situation when axis eccentricity is occurred or when the diameter is wrong, the length of the misalignment is 0.03 inch for one seat track (2) on x axis (total 0.06 inch for two seat tracks (2)) and the length of the misalignment is 0.03 inch for two seat tracks (2) on y axis (FIG. 5). This situation is called as “track splice condition”. The value of diameter of the hole, which must be 0.78 inch, decreases in such a condition.

Rear main fitting body (5) is the component which provides setting of the position of the seat (7), after rear leg (6) of the seat (7) is connected to the seat track (2).

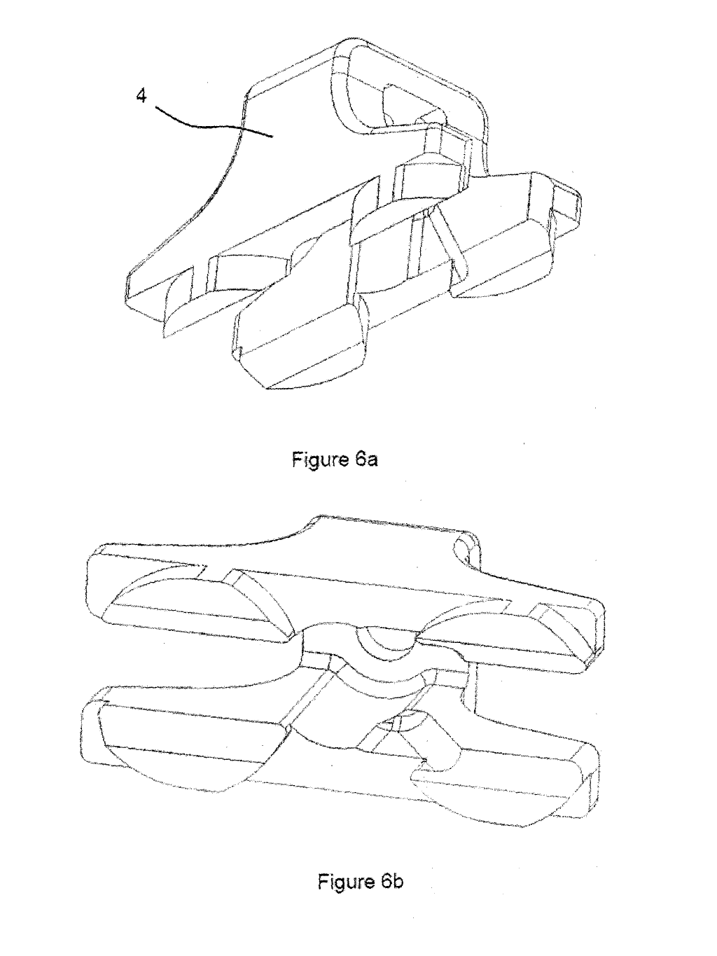

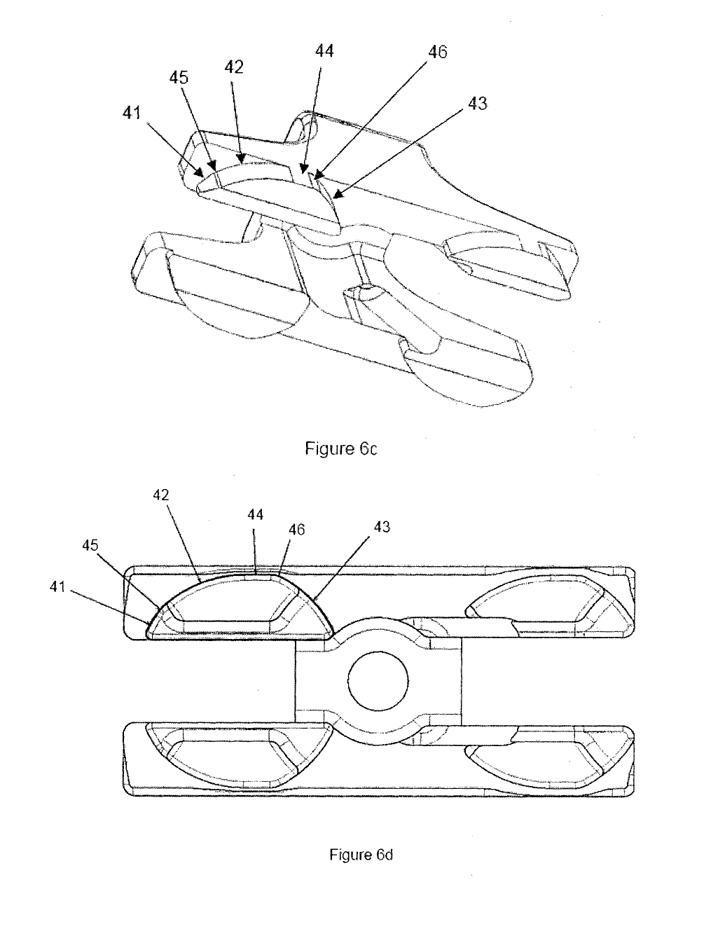

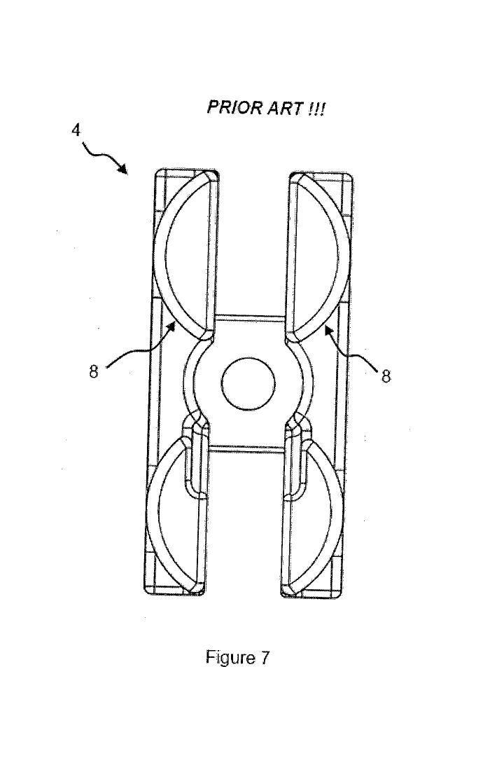

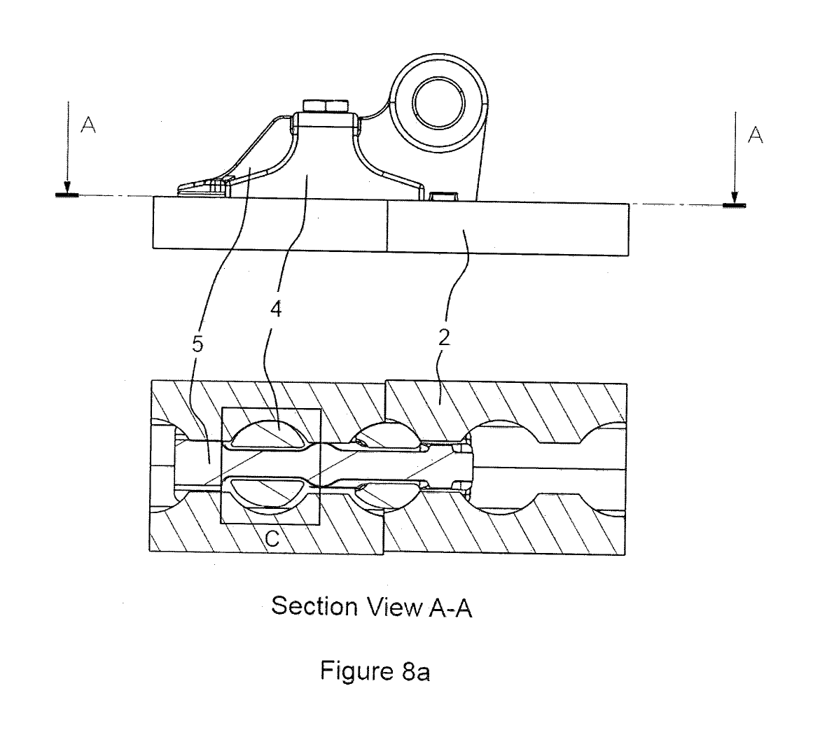

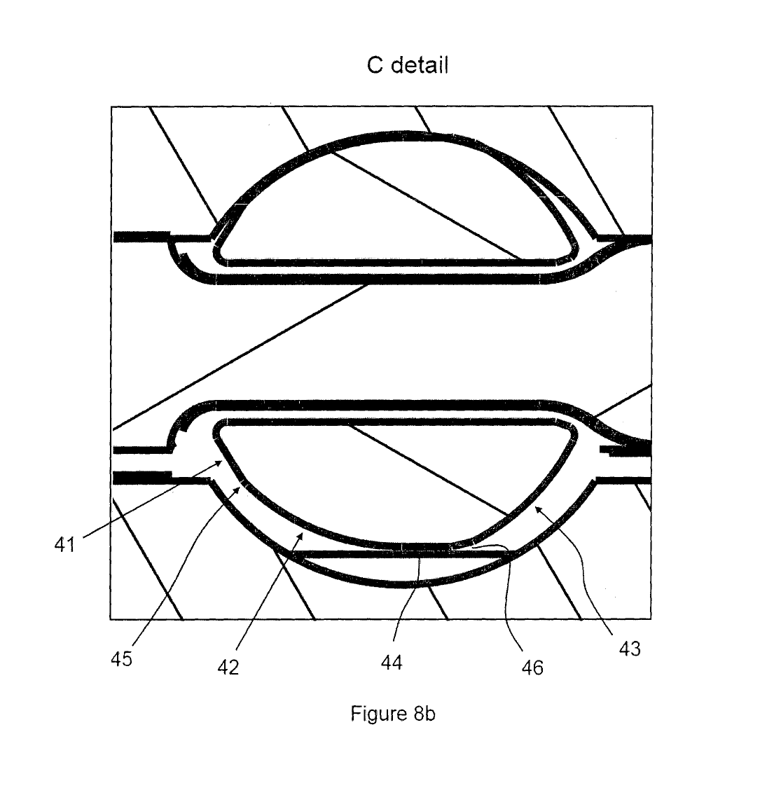

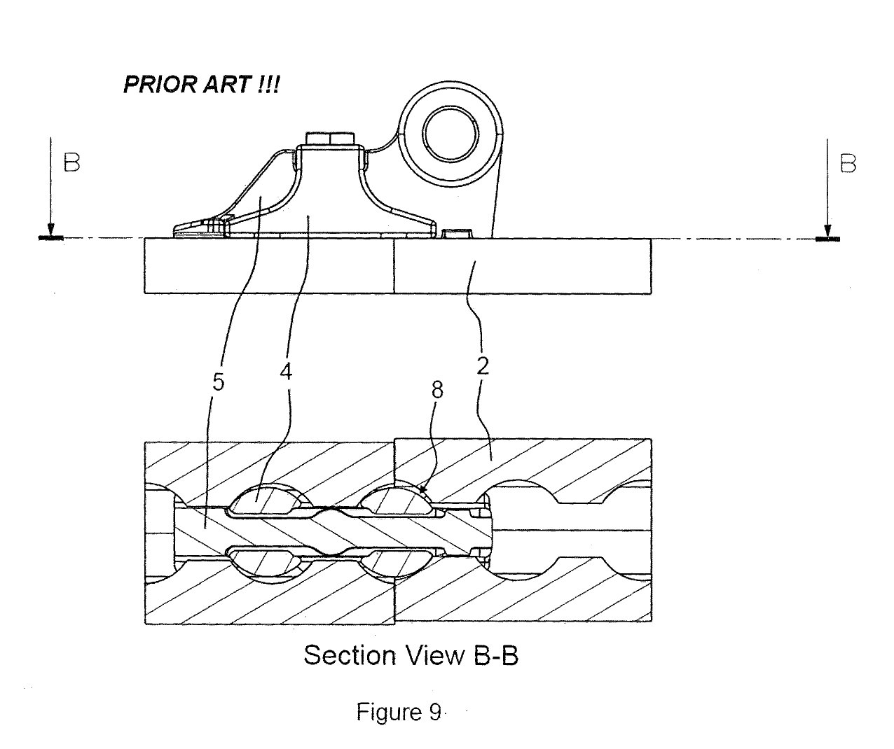

Shear plunger (4) fastens the rear main fitting body (5) to the seat track (2) and prevents movement of the rear main fitting body (5). Current (prior art) shear plungers (4) have circular geometry and contact surface (8) of said shear plunger (4) has single radius value which, is between 0.703 and 0.713 to fit into track splice condition. This value is significantly reduced from the recommended value which is 0.78, considering the fact that shear plunger (4) is very crucial component of the seat assembly. However, the improved shear plunger (4) which subjects to invention, has six surfaces named as radiused surface 1 (41), radiused surface 2 (42), radiused surface 3 (43), flat transition area (44), radiused transition surface 1 (45) and radiused transition surface 2 (46) (FIG. 6c, 6d, 8b). When FIG. 8a and FIG. 9 are looked at carefully, the difference of surface contact provided, between the shear plunger (4) subjected to invention and shear plunger (4) belongs to prior art will be seen. Contact surface between shear plunger (4) and seat track (2) is so important for distribution of high forces applied to shear plunger (4). The characteristics and positions of all six surfaces are indicated below:
Radiused surface 1 (41): Radiused surface 1 (41) has the diameter which is the recommended diameter which provides sufficient endurance in structural tests. Said recommended diameter is 0.78 inch. The value of 0.78 inch is determined by airframe manufacturers, considering passenger security and certification tests.
Radiused transition surface 1 (45): Radiused transition surface 1 (45) is formed between radiused surface 1 (41) and radiused surface 2 (42). Radiused transition surface 1 (45) provides softer transition between radiused surface 1 (41) and radiused surface 2 (42). Radiused transition surface 1 (45) diminishes the danger of failure on transition sections of part.
Radiused surface 2 (42): The diameter of radiused surface 2 (42) is also 0.78 inch. Radiused surface 2 (42) is positioned between radiused transition surface 1 (45) and flat transition area (44).
Flat transition area (44): Flat transition area (44) helps shear plunger (4) to have recommended radius value on both halves. The length of the flat transition area (44) is determined for maximum surface contact thus flat transition area (44) also helps shear plunger (4) to have maximum surface contact with seat track (2). Flat transition area (44) is formed between radiused surface 2 (42) and radiused transition surface 2 (46). Flat transition area (44) prevents merging which occurs because of the diameters of radiused surface 1 (41), radiused surface 2 (42) and radiused surface 3 (43) has high value.
Radiused transition surface 2 (46): Radiused transition surface 2 (46) is formed between flat transition area (44) and radiused surface 3 (43). Radiused transition surface 2 (46) provides softer transition between flat transition area (44) and radiused surface 3 (43). Radiused transition surface 2 (46) also diminishes the danger of failure on transition sections of part.
Radiused surface 3 (43): The diameter of radiused surface 3 (43) is also 0.78. Radiused surface 3 (43) is positioned after radiused transition surface 2 (46) and adjacent to radiused transition surface 2 (46).

As mentioned above, radiused surface 1 (41), radiused surface 2 (42) and radiused surface 3 (43) have the diameter which value is 0.78 inch. On the other hand, flat transition area (44), radiused transition surface 1 (45) and radiused transition surface 2 (46) are formed on shear plunger (4), whose locations are given above. Thanks to the diameter value of 0.78 inch and thanks to said locations, better endurance is provided and shear plunger (4) fits into seat track (2) while maximum surface contact is provided between shear plunger (4) and seat track (2).

1. A shear plunger which is a part of a fitting group which connects an aircraft seat to a seat track which is placed on the inside floor of the aircraft and said shear plunger is characterized in that it comprises:
a first radiused surface which has 0.78 inch diameter,
a second radiused surface which has 0.78 inch diameter,
a third radiused surface 3 (43) which has 0.78 inch diameter,
a flat transition area which is flat, and which is formed between said second radiused surface and a second radiused transition surface; and
a first radiused transition surface which has radiused form; and which is formed between said first radiused surface and said second radiused surface,
said second radiused transition surface having a radiused form; and which is formed between said flat transition area and said third radiused surface in order to provide maximum surface contact between the shear plunger and the seat track.
